(19) United States
(12) Patent Application Publication
(10) Pub. No.: US 2013/0229280 A1
(43) Pub. Date: Sep. 5, 2013

(54) MOBILE INFORMATION PROCESSING APPARATUS AND ITS CONTROL METHOD

(71) Applicant: CANON KABUSHIKI KAISHA, Tokyo (JP)

(72) Inventor: Yuichi Nishii, Kawasaki-shi (JP)

(73) Assignee: CANON KABUSHIKI KAISHA, Tokyo (JP)

(21) Appl. No.: 13/773,767

(22) Filed: Feb. 22, 2013

(30) Foreign Application Priority Data
Mar. 1, 2012 (JP) 2012-045723

(51) Int. Cl. G08B 21/18

(52) U.S. Cl. CPC G08B 21/185
USPC 340/539.11

(57) ABSTRACT

A mobile information processing apparatus for wireless communication with a radio communication cassette comprises a first obtaining unit that obtains a remaining battery level of a battery provided in the radio communication cassette, a second obtaining unit that obtains power consumption necessary for the radio communication cassette to perform an inspection based on an inspection order, a discriminating unit that discriminates, based on the obtained remaining battery level and power consumption, whether or not the inspection using the radio communication cassette can be executed, a displaying unit that displays battery information of the radio communication cassette based on the discrimination, and a control unit that enables the second obtaining unit, the discriminating unit and the displaying unit to run, when the inspection order for the radio communication cassette is obtained or updated by connecting the mobile information processing apparatus to a network.

### BACKGROUND OF THE INVENTION

1. Field of the Invention

The present invention relates to a mobile information processing apparatus for wireless communication with a radio communication cassette, and to a control method for such an information processing apparatus.

2. Description of the Related Art

In the related arts, a requirement to realize a high efficiency and a high speed of an inspection by converting medical image information of a patient which is generated in a hospital into digital data and by storing and transmitting the digital data has been increasing. Therefore, even in the field of the X-ray radiographing, a digital system for outputting digital data by using an X-ray detector such as an FPD (Flat Panel Detector) or the like has widely been used in place of a screen/film system so far. The number of cases where a radio communicating function is provided for the X-ray detector is also increasing.

Among them, with respect to the battery management of a radio communication cassette, in order to avoid a battery from being replaced during an inspection, there has also been proposed such a system that discriminates inspections which can be performed with the remaining battery level of a battery that is being used at present, and, if it is discriminated that one of the inspections cannot be performed with the present remaining battery level, displays a message for encouraging the administrator to replace the battery before the inspection is performed (refer to Japanese Patent Application Laid-Open No. 2011-200427).

In the case of using a mobile X-ray radiographing apparatus using the radio communication cassette, doctors usually connect the apparatus to a network in an X-ray room or the like to receive an inspection order, and then make rounds to the sickroom. At this time, in many cases, the sickroom is not connected to the network.

In most of the cases, the charging of a battery of the radio communication cassette is performed in the X-ray room or the like and a spare battery is kept in the X-ray room, too.

When considering such a point, in the case of using the mobile X-ray radiographing apparatus, there is such a problem as will be mentioned hereinbelow. That is, in the related arts, inspections are continuously performed in the X-ray room as a prerequisite. A fact that a certain inspection cannot be performed with the remaining battery level is notified before one-precedent inspection of the inspection which cannot be performed with the remaining battery level is finished. This means, in the case of using the mobile X-ray radiographing apparatus, that the battery replacement is encouraged, in the sickroom under the doctor's round. Therefore, since the spare battery is placed in the X-ray room, the doctor has to go back to the X-ray room in order to fetch the spare battery, which blocks the progress of the inspection.

The invention is made in consideration of such a drawback as mentioned above and it is an object of the invention to encourage, in a mobile X-ray radiographing apparatus, the battery replacement in a radio communication cassette or the preparation of a spare battery for the radio communication cassette, so as not to block an inspection when an inspection order is received via a network.

### SUMMARY OP THE INVENTION

In order to solve the above problems, the invention provides a mobile information processing apparatus for wireless communication with a radio communication cassette, the apparatus comprising: a first obtaining unit that obtains a remaining battery level of a battery provided in the radio communication cassette; a second obtaining unit that obtains power consumption necessary for the radio communication cassette to perform an inspection based on an inspection order; a discriminating unit that discriminates, based on the remaining battery level obtained by the first obtaining unit and the power consumption obtained by the second obtaining unit, whether or not the inspection using the radio communication cassette can be executed; a displaying unit that displays battery information of the radio communication cassette based on a discrimination made by the discriminating unit; and a control unit that enables the second obtaining unit, the discriminating unit and the displaying unit to run, when the inspection order for the radio communication cassette is obtained or updated by connecting the mobile information processing apparatus to a network.

Further features of the present invention will become apparent from the following description of exemplary embodiments with reference to the attached drawings.

### BRIEF DESCRIPTION OP THE DRAWINGS

FIG. 1 is a block diagram illustrating a construction of an information processing apparatus which is provided for a mobile X-ray radiographing apparatus according to the first embodiment.

FIG. 2 is a flowchart showing a processing operation of the information processing apparatus according to the first embodiment.

FIG. 3 is a flowchart showing details of a calculating process of total power consumption of every sensor.

FIG. 4 is a flowchart showing a processing operation of an information processing apparatus according to the second embodiment.

FIG. 5 is a flowchart showing details of a calculating process of total power consumption of every sensor type.

FIG. 6 is a flowchart showing a processing operation of an information processing apparatus according to the third embodiment.

FIG. 7 is a flowchart showing details of a calculating process of total power consumption of every battery type.

FIG. 8 is a diagram illustrating a specific example of an inspection order.

FIG. 9 is a diagram illustrating a specific example in which radiographing permission/inhibition information is displayed onto a work list.

### DESCRIPTION OF THE EMBODIMENTS

Exemplary embodiments of the invention will be described hereinbelow with reference to the drawings.

### First Embodiment

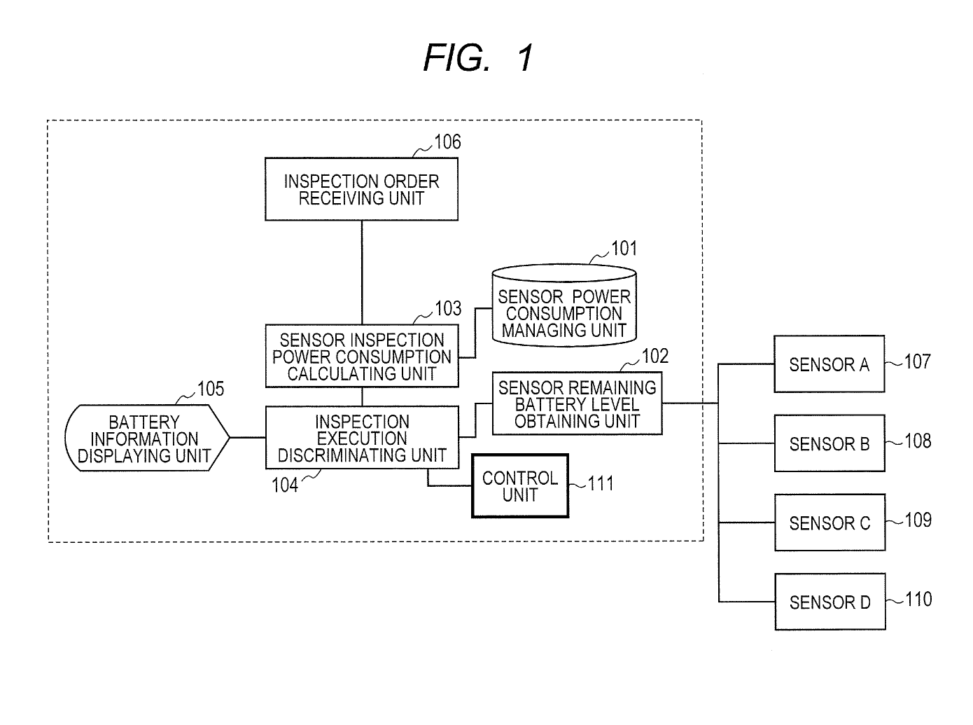

FIG. 1 is a block diagram illustrating the construction of an information processing apparatus which is provided for a mobile X-ray radiographing apparatus according to the first embodiment. This information processing apparatus can be connected to a wired connection cassette in a wired manner and can communicate with a radio communication cassette in a wireless manner. That is, cassettes (hereinbelow, referred to as “sensors”) 107 to 110 are a radio communication type or a wired connection type.

A sensor power consumption managing unit 101 manages the power consumption of the radio communication sensor. A sensor remaining battery level obtaining unit 102 obtains the remaining battery level of a battery provided in the radio communication sensor.

A sensor inspection power consumption calculating unit 103 calculates the power consumption (presumed consumption amount) necessary for the radio communication sensor to perform an inspection, based on an inspection order newly obtained or updated by the reception by an inspection order receiving unit 106.

An inspection execution discriminating unit 104 discriminates whether or not an inspection using the radio communication sensor can be executed, based on the power consumption calculated by the sensor inspection power consumption calculating unit 103 and the latest remaining battery level obtained by the sensor remaining battery level obtaining unit 102.

A battery information displaying unit 105 displays battery information serving as information regarding the battery, based on the discrimination performed by the inspection execution discriminating unit 104.

The inspection order receiving unit 106 receives an inspection order. The inspection order includes, for each of one or more inspections, items such as receipt number, inspection time/date, patient ID, patient name, and sensors to use.

In the embodiment, it is assumed that sensors 107 to 110 are of four types A, B, C and D, and that the sensors of types A, B, and C can be used both in radio connection and in wired connection and the sensors of type D are used in wired connection. It is assumed that the sensors A and B use a battery of type X, and the sensor C uses a battery of type Y. It is further assumed that the apparatus has two sensors A (A1, A2), one sensor B (B1), one sensor C (C1), and one sensor D (D1).

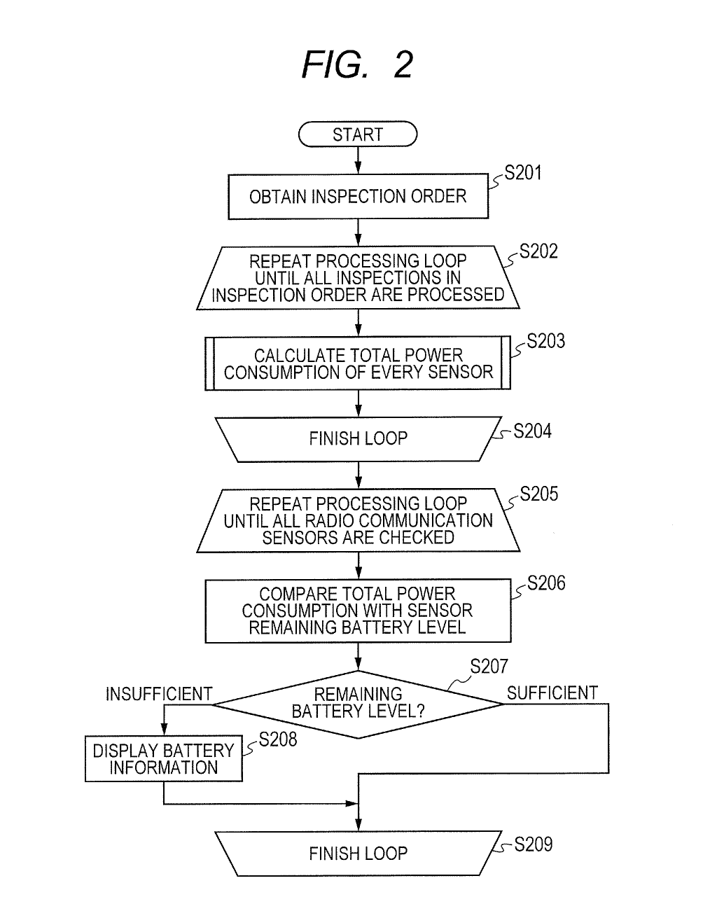

FIG. 2 illustrates a processing operation of the information processing apparatus according to the embodiment. An inspection order is newly obtained or updated through reception by the inspection order receiving unit 106 (step S201).

The sensor inspection power consumption calculating unit 103 checks, all inspections included in the received inspection order one by one (steps S202 to S204) and calculates total power consumption of each sensor (step S203). The calculation in this instance is performed also in consideration of a radiographing time (X-ray accumulation time; in the case of the radiographing of a long time, a large amount of power is consumed), the number of using times of the battery, and a deterioration depending on an aging change.

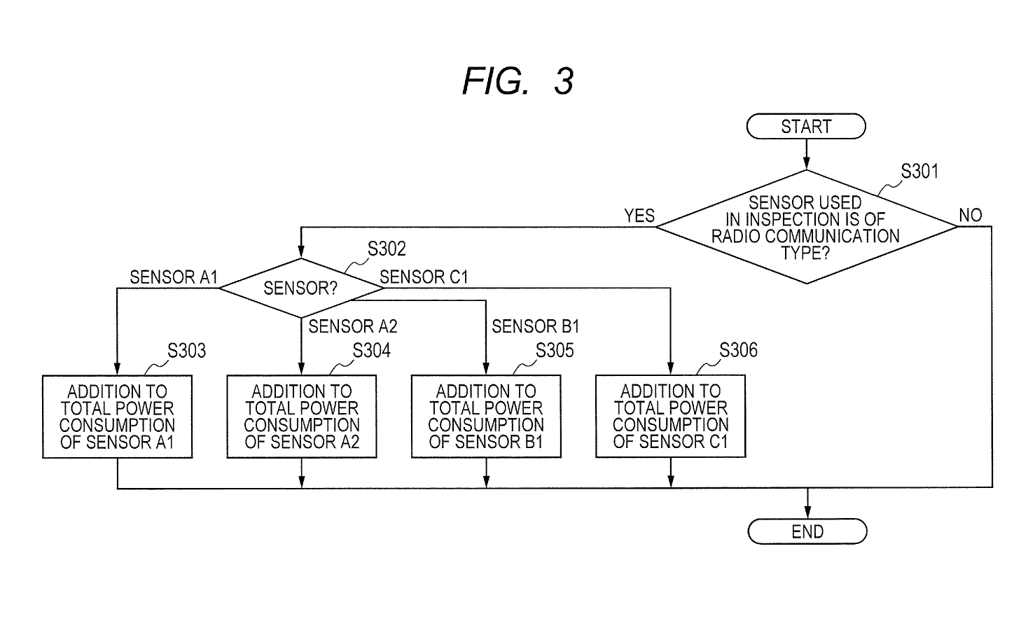

FIG. 3 illustrates details of the calculating process of the total power consumption of each sensor in step S203. Based on the inspection order, it is discriminated whether or not the sensor to use in the inspection is of radio communication type (step S301). If the sensor is of radio communication type, the total power consumption is calculated for every sensor (steps S302 to S306). Even if it is of radio communication type, the sensor is excluded from the calculation of the total power consumption for inspections for which the wired connection is used, since such inspections are not aimed at in this embodiment.

Subsequently, the inspection execution discriminating unit 104 discriminates all of the registered radio communication sensors one by one (steps S205 to S209). A comparison is made between the total power consumption calculated in step S203 and the latest remaining battery level obtained in the sensor remaining battery level obtaining unit 102 (step S206), and it is discriminated based on the comparison whether or not the remaining battery level is sufficient (step S207). Thus, if it is determined that the remaining battery level is insufficient, the battery information is displayed by the battery information displaying unit 105 (step S208). If it is determined that the remaining battery level is sufficient, the battery information is not particularly displayed, but a message showing that the remaining battery level is sufficient may be displayed. A control unit 111 controls the sensor inspection power consumption calculating unit 103, the inspection execution discriminating unit 104 and the battery information displaying unit 105 to obtain the inspection power consumption, to make the discrimination about the execution of the inspection, and to display the battery information, respectively, when the inspection order is obtained or updated by connecting the apparatus to the network. It is possible to execute an inspection without any interruptions during the doctor's round, by executing those processing when the inspection order is obtained or updated by connecting the apparatus to the network.

When the radio communication sensor is not connected, the sensor remaining battery level obtaining unit 102 does not obtain the remaining battery level or determines that the battery is on a full charge.

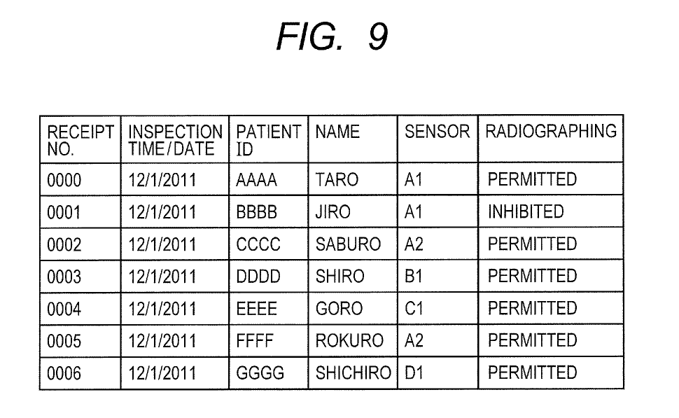

A message may be displayed, as the battery information mentioned above, that suggests replacing the battery by a new one, or encourages preparing N spare batteries. To display the message, a pop-up display screen is conveniently used, but other displaying methods may be used. Or, information may be displayed on a work list display screen for every inspection, indicating whether or not radiographing is permitted with the present battery, as illustrated in FIG. 9. Furthermore, if information on spare batteries is managed, it may be useful to display specific information identifying one of the spare batteries to use as a replacement.

The inspection execution discriminating unit 104 executes a discrimination again and the battery information displaying unit 105 updates displayed information, each time the information on the remaining battery level obtained by the sensor remaining battery level obtaining unit 102 is updated, for example, through the replacement of the battery currently provided in the sensor by a spare battery during the displaying of the battery information.

If the remaining battery level obtained by the sensor remaining battery level obtaining unit 102 is obviously insufficient, that is, when the remaining battery level is lower than a predetermined threshold value, the battery information may be displayed at timing other than the timing for newly obtaining or updating the inspection order.

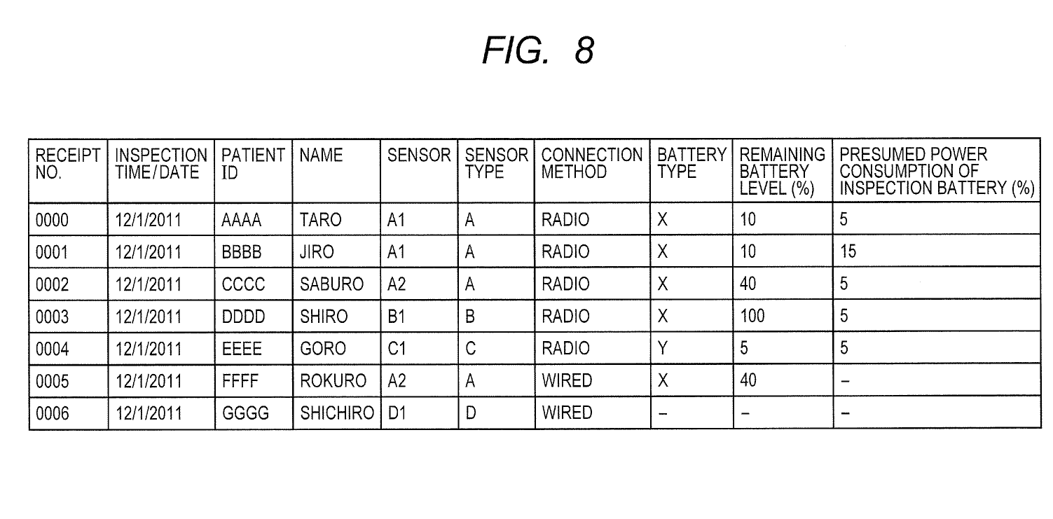

The flow as mentioned above will be specifically described with respect to the inspection order in FIG. 8 as an example. As mentioned above, it is assumed that sensors 107 to 110 are of four types A, B, C and D, that the sensors of types A, B, and C can be used both in radio connection and in wired connection and the sensors of type D are used in wired connection, that the sensors A and B use a battery of type X, and the sensor C uses a battery of type Y, and that the apparatus has two sensors A (A1, A2), one sensor B (B1), one sensor C (C1) and one sensor D (D1). It is now assumed that the inspection of receipt No. 0001 requires a long time radiographing, and therefore consumes more battery power than the other inspections.

According to the inspection order under such a condition, since the sensor A1 is used for the receipt Nos. 0000 and 0001, the presumed consumption amount (total power consumption) of the sensor A1 is equal to 20% (=5%+15%), whereas the remaining battery level is equal to 10%. Therefore, the battery information displaying unit 105 displays the battery information, encouraging the replacement of the battery by a new one or the carrying of one spare battery of type X.

The sensor A2 is used for the receipt Nos. 0002 and 0005, but the receipt number 0005 is excluded from the calculation, since the sensor A2 is used in wired connection for the inspection of this receipt number. Thus, the presumed consumption amount (total power consumption) of the sensor A2 is equal to 5%, whereas the remaining battery level is equal to 40%. Therefore, there is no problem with respect to the battery of the sensor A2.

The sensor B1 is used only for the receipt No. 0003. Since this sensor is not connected, the remaining battery level is calculated on the assumption that it is equal to 100%. Thus, the presumed consumption amount (total power consumption) of the sensor B1 is equal to 5%, whereas the remaining battery level is equal to 100%. Therefore, there is no problem with respect to the battery of the sensor A2. If the battery information is subsequently obtained from the sensor, the remaining battery level is calculated again.

The sensor C1 is used only for the receipt No. 0004. The presumed consumption amount (total power consumption) of the sensor C1 is equal to 5%, whereas the remaining battery level is equal to 5%. Therefore, the battery information displaying unit 105 displays the battery information, indicating that it is better to replace the battery by a new one or to carry one spare battery of type Y, although the battery would be probably OK. The sensor D1 is excluded from consideration, since it is a wired connection sensor.

By the control of the information processing apparatus as discussed above, it is possible to encourage the replacement of the battery provided in the radio communication sensor or the preparation or a spare battery, at the timing when the inspection order is received (which is useful timing for the mobile X-ray radiographing apparatus), that is, at the timing when the inspection order is newly obtained or updated. According to this control processing, the inspection can be executed without any interruptions.

### Second Embodiment

The second embodiment will now be described. The construction of the information processing apparatus and the sensors used in this embodiment will not be described, since it is identical to that in the first embodiment.

In the first embodiment, the total power consumption is calculated for every sensor. In the second, embodiment, the total power consumption is calculated for every sensor type. The sensor type includes types A, B, C, and D in the embodiment. Since the sensors of the same; type have the same feature, one of the sensors to use for an inspection can be easily replaced by another of the sensors.

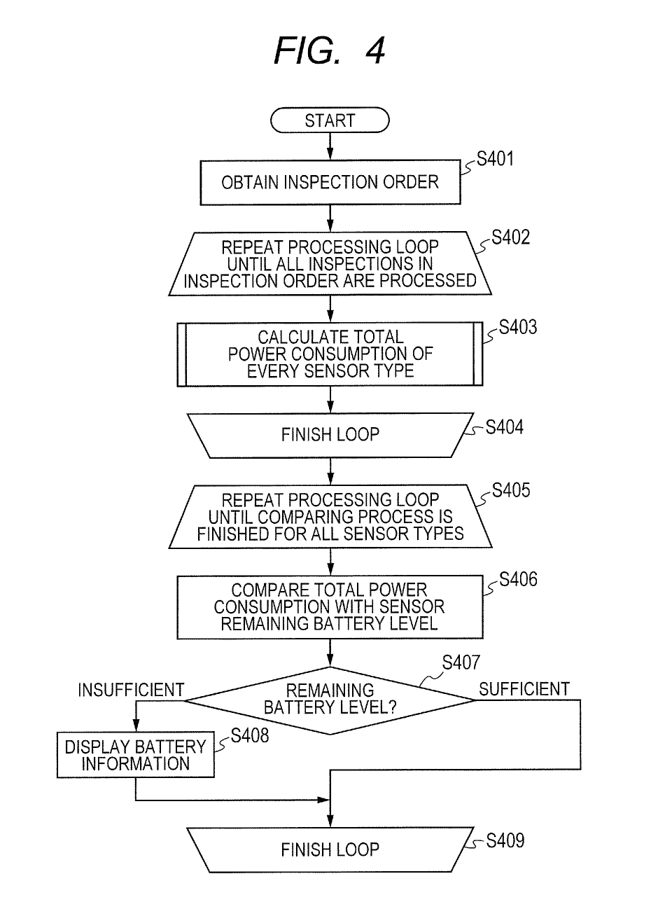

FIG. 4 illustrates the processing of the information processing apparatus according to the embodiment. The flow of processes is similar to that in FIG. 2 of the first embodiment except that the sensor inspection power consumption calculating unit 103 calculates the total power consumption for every sensor type in steps S402 to S404.

The inspection execution discriminating unit 104 compares the total power consumption with the remaining battery level for every sensor type in steps S405 to S409.

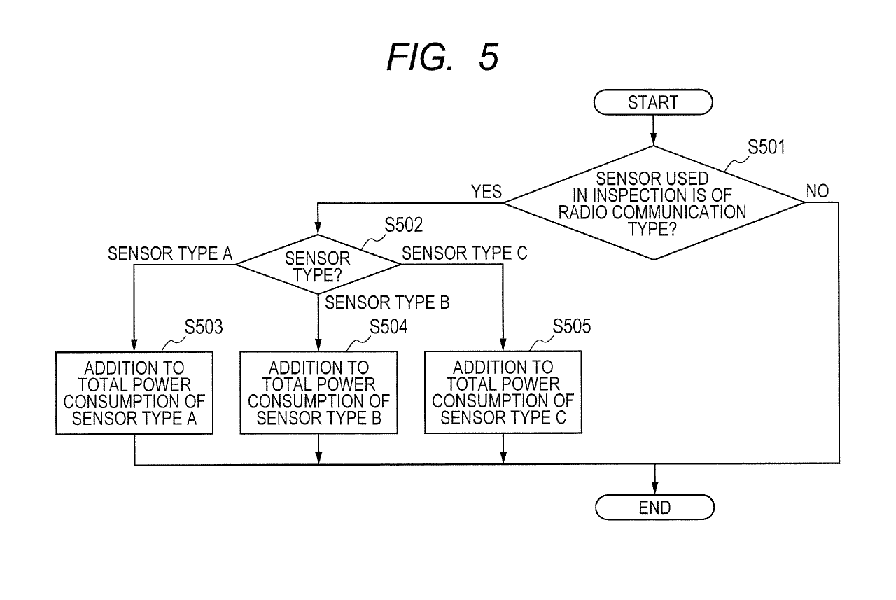

FIG. 5 illustrates details of the calculating process of the total power consumption of every sensor type in step S403. Based on the inspection order, it is discriminated whether or not the sensor to use in the inspection is of radio communication type (step S501). If the sensor is of radio communication type, the total power consumption is calculated for every sensor type (steps S502 to S505). Even if it is of radio communication type, the sensor is excluded from the calculation of the total power consumption for inspections for which the wired connection is used, as discussed above with respect to the first embodiment.

In the embodiment, the inspection execution discriminating unit 104 discriminates whether or not the inspection using the radio communication sensor can be executed, based on least one of (a) the total remaining battery level, (b) the lowest remaining battery level among the sensors and (c) the highest remaining battery level among the sensors.

In addition to the battery information shown in the first embodiment, the battery information in this embodiment may include a message that suggests battery exchange between the sensors of the same type or that suggests replacement of one of the sensors of the same type to use for inspection by another one of the sensors of the same type.

The flow as mentioned above will be specifically described with respect to the inspection order of FIG. 8 as an example. For example, the sensor of the sensor type A is used for the receipt Nos. 0000, 0001, 0002 and 0005, but the receipt No. 0005 is excluded from the calculation, since this sensor is used in wired connection for the inspection of this receipt number. Thus, the presumed consumption amount (total power consumption) of the sensor of the sensor type A is equal to 25%, whereas the remaining battery level is equal to 50%. Therefore, there is no problem with respect to the battery. When the inspection is progressed in accordance with the inspection order, the remaining battery level of the sensor A1 is insufficient (the total power consumption of the sensor A1 is equal to 20%, whereas the remaining battery level is equal to 10%), and the remaining battery level of the sensor A2 is sufficient (the total power consumption of the sensor A2 is equal to 5%, whereas the remaining battery level is equal to 40%). Therefore, the battery information may include a message that suggests the switching between the sensors A1 and A2 such that an inspection scheduled to be executed with the sensor A1 is executed with the sensor A2. Or the switching may be automatically executed.

### Third Embodiment

The third embodiment will now be described. The construction of the information processing apparatus and the sensors used in this embodiment will not be described, since it is identical to that in the first embodiment.

In the second embodiment, the total power consumption is calculated for every sensor type. In the third embodiment, the total power consumption is calculated for every battery type. The battery type includes types X and Y type in the embodiment. The batteries of the same type can be easily replaced by each other.

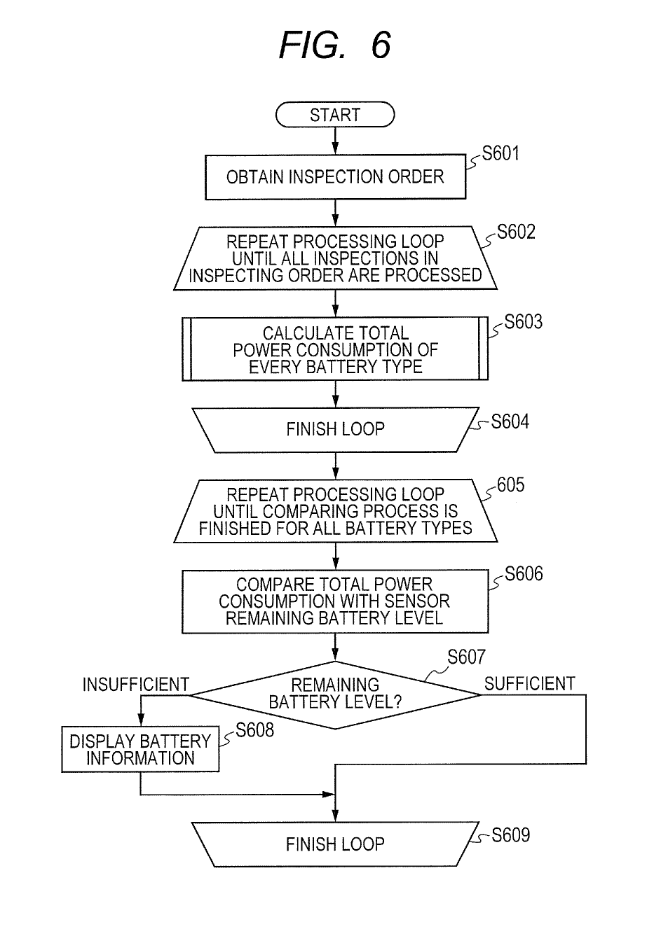

FIG. 6 illustrates the processing of the information processing apparatus according to the embodiment. The flow of processes is similar to that in FIG. 2 of the first embodiment and that in FIG. 4 of the second embodiment except that the sensor inspection power consumption calculating unit 103 calculates the total power consumption for every battery type in steps S601 to S603.

The inspection execution discriminating unit 104 compares the total power consumption with the remaining battery level for every battery type in steps S605 to S603.

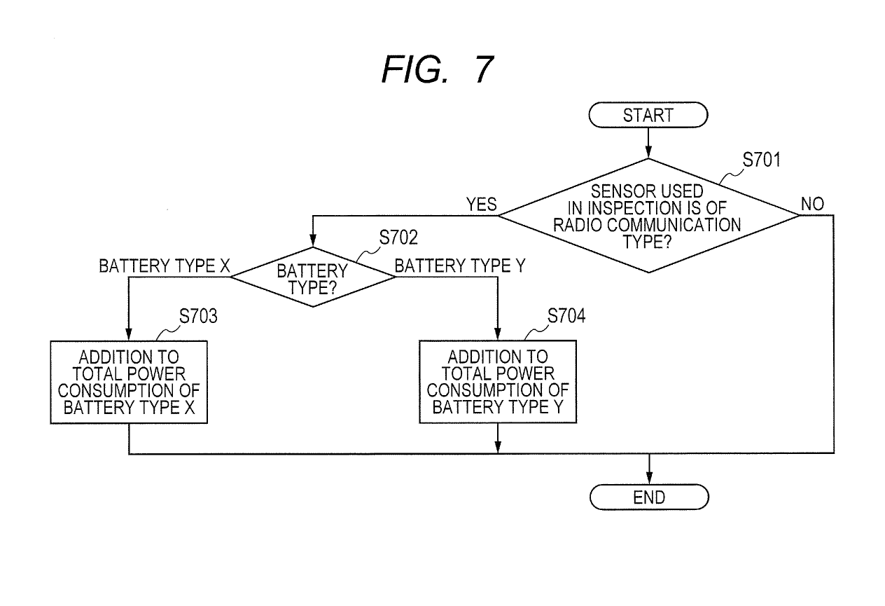

FIG. 7 illustrates details of the calculating process of the total power consumption of every sensor type in step S603. Based on the inspection order, it is discriminated whether or not the sensor to use in the inspection is of the radio communication type (step S701). If the sensor is of radio communication type, the total power consumption is calculated for every sensor type (steps S702 to S704). Even if it is of radio communication type, the sensor is excluded from the calculation of the total power consumption for inspections for which the wired connection is used, as discussed above with respect to the first and second embodiments.

In the embodiment, the inspection execution discriminating unit 104 discriminates whether or not the inspection using the radio communication sensor can be executed, based on least one of (a) the total remaining battery level, (b) the lowest remaining battery level among the sensors and (c) the highest remaining battery level among the sensors.

In addition to the battery information shown in the first embodiment, the battery information in this embodiment may include a message that suggests battery exchange between the sensors having the batteries of the same type or that suggests replacement of one of the sensors having the batteries of the same type to use for inspection by another one of the sensors having the batteries of the same type.

The flow as mentioned above will be specifically described with respect to the inspection order of FIG. 8 as an example. For example, the battery of type X is used for the receipt Nos. 0000 to 0003 and 0005, but the receipt No. 0005 is excluded from the calculation, since the sensor is used in wired connection for the inspection of this receipt number. Thus, the presumed consumption amount (total power consumption) of the sensor of the battery type X is equal to 30%, whereas the remaining battery level is equal to 150%. Therefore, there is no problem with respect to the battery of type X.

In view of the total value calculated, since the presumed consumption amount is equal to 30% and the remaining battery level is equal to 150%, the remaining battery level is sufficient. When the inspection is progressed in accordance with the inspection order, the remaining battery level of the sensor A1 is insufficient (the total power consumption of the sensor A1 is equal to 20%, whereas the remaining battery level is equal to 10%). On the other hand, the remaining battery level of the sensor B1 is equal to 100% and the remaining battery level of the sensor A2 is equal to 40%. However, there is no confidence with respect to the sensor B1 in spite of the indication of the remaining battery level of 100%, since the sensor B1 is not connected. In the present instance, since all the inspections can be performed with the sensor A2 only. Therefore, the battery information may include a message that suggests the switching between the sensors such that an inspection scheduled to be executed with the sensor A1 or B1 is executed with the sensor A2. Or the switching may be automatically executed.

### Other Embodiments

Embodiments of the present invention can also be realized by a computer of a system or apparatus that reads out and executes computer-executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer-executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile, disc (DVD), or Blu-Ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-045723, filed Mar. 1, 2012, which is hereby incorporated by reference herein in its entirety.

What is claimed is:

1. A mobile information processing apparatus for wireless communication with a radio communication cassette, comprising:
a first obtaining unit configured to obtain a remaining battery level of a battery provided in the radio communication cassette;
a second obtaining unit configured to obtain power consumption necessary for the radio communication cassette to perform an inspection based on an inspection order;
a discriminating unit configured to discriminate, based on the remaining battery level obtained by the first obtaining unit and the power consumption obtained by the second obtaining unit, whether or not the inspection using the radio communication cassette can be executed;
a displaying unit configured to display battery information of the radio communication cassette based on a discrimination made by the discriminating unit; and
a control unit configured to enable the second obtaining unit, the discriminating unit and the displaying unit to run, when the inspection order for the radio communication cassette is obtained or updated by connecting the mobile information processing apparatus to a network.

2. The mobile information processing apparatus according to claim 1, wherein a plurality of the radio communication cassettes are used, and the second obtaining unit calculates the power consumption for every one of the plurality of radio communication cassettes.

3. The mobile information processing apparatus according to claim 2, wherein the plurality of radio communication cassettes have respective cassette types, and the second obtaining unit calculates the power consumption for every one of the cassette types.

4. The mobile information processing apparatus according to claim 2, wherein the plurality of radio communication cassettes have respective batteries of respective battery types, and the second obtaining unit calculates the power consumption for every one of the battery types.

5. The mobile information processing apparatus according to claim 1, wherein the discriminating unit excludes, from discrimination, an inspection for which the radio communication cassette is used by a wired connection.

6. The mobile information processing apparatus according to claim 1, wherein the second obtaining unit calculates the power consumption based on the length of a radiographing time.

7. The mobile information processing apparatus according to claim 3, wherein the discriminating unit discriminates whether or not the inspection using the radio communication cassette can be executed, based on at least one of (a) a total remaining battery level, (b) a lowest remaining battery level among the plurality of radio communication cassettes and (c) a highest remaining battery level among the plurality of radio communication cassettes.

8. The mobile information processing apparatus according to claim 7, wherein when one of the plurality of radio communication cassettes is not connected, the first obtaining unit excludes, from obtaining, the remaining battery level for the one radio communication cassette or determines that the battery provided in the one radio communication cassette is on a full charge.

9. The mobile information processing apparatus according to claim 1, wherein each time information on the remaining battery level obtained by the first obtaining unit is updated, the discriminating unit makes a discrimination again and the displaying unit updates the battery information.

10. The mobile information processing apparatus according to claim 1, wherein the displaying unit displays a message that suggests replacing the battery by a new battery or that encourages preparing a spare battery.

11. The mobile information processing apparatus according to claim 3, wherein the displaying unit displays a message that suggests battery exchange between two of the plurality of radio communication cassettes of the same type or that suggests replacing one of the two radio communication cassettes to use for inspection by the other one of the two radio communication cassettes.

12. The mobile information processing apparatus according to claim 4, wherein the displaying unit displays a message that suggests battery exchange between two of the plurality of radio communication cassettes having the batteries of the same type or that suggests replacing one of the two radio communication cassettes to use for inspection by the other one of the two radio communication cassettes.

13. The mobile information processing apparatus according to claim 1, wherein the displaying unit displays information indicating whether or not radiographing is permitted for every inspection included in the inspection order.

14. The mobile information processing apparatus according to claim 1, wherein when the remaining battery level obtained by the first obtaining unit is lower than a predetermined threshold value, the displaying unit displays the battery information also at timing other than timing for newly obtaining or updating the inspection order.

15. A method of controlling a mobile information processing apparatus for wireless communication with a radio communication cassette, the method comprising;
obtaining a remaining battery level of a battery provided in the radio communication cassette;
when an inspection order for the radio communication cassette is obtained or updated, obtaining power consumption necessary for the radio communication cassette to perform an inspection based on the inspection order;
discriminating, based on the obtained remaining battery level and the obtained power consumption, whether or not the inspection using the radio communication cassette can be executed;
displaying battery information of the radio communication cassette based on a discrimination made in the discriminating; and
enabling the second obtaining, the discriminating and the displaying to run, when the inspection order for the radio communication cassette is obtained or updated by connecting the mobile information processing apparatus to a network.

16. A non-transitory computer-readable storage medium storing a computer program that causes a computer to execute the method according to claim 15.
